(19) United States
(12) Patent Application Publication
(10) Pub. No.: US 2010/0068458 A1
(43) Pub. Date: Mar. 18, 2010

(54) INORGANIC DECORATIVE BUILDING BOARD AND MANUFACTURING METHOD FOR THE SAME

(76) Inventor: Wataru SAKAI, Nagoya-shi (JP)

Correspondence Address: BIRCH STEWART KOLASCH & BIRCH, PO BOX 747, FALLS CHURCH, VA, 22040-0747, US

(21) Appl. No.: 12/545,214

(22) Filed: Aug. 21, 2009

(30) Foreign Application Priority Data
Sep. 12, 2008 (JP) JP2008-234783

(51) Int. Cl. B32B 5/16; B05D 1/36; B05D 7/24

(52) U.S. Cl. 428/142; 427/203; 427/201

(57) ABSTRACT

An unhardened inorganic board is shaped by press clamping the surface of an unhardened inorganic mat having a colored surface layer using an embossing template. A semi-hardened inorganic board is obtained by performing primary curing of the unhardened inorganic board, and coating the surface of the semi-hardened inorganic board with a primary sealer. The semi-hardened inorganic board coated with the primary sealer is autoclave cured to obtain a hardened inorganic board. The surface of the hardened inorganic board is coated with a powdery or granular material fixing sealer and, thereafter, an ornamental powdery or granular material is dispersed onto the surface of the hardened inorganic board. The surface of the hardened inorganic board on which the ornamental powdery or granular material has been dispersed is coated with a finishing transparent paint.

### BACKGROUND OF THE INVENTION

1. Field of the Invention

The present invention relates to an inorganic decorative building board and more specifically relates to an inorganic decorative building board that is formed by using a colored substrate layer and an ornamental powdery or granular material so as to present the look of natural materials and that has excellent decorativeness and durability, as well as a manufacturing method by which the inorganic decorative building board can be manufactured with good productivity. In particular, the inorganic decorative building board of the present invention is suitable for use as an exterior building material having on the surface thereof an embossed irregular pattern portion such as a stone pattern, a ceramic tile pattern, or a brick pattern.

2. Description of the Related Art

Inorganic decorative building boards have been conventionally used in buildings such as houses, mainly as an exterior building material and the like, and inorganic decorative building boards are manufactured in the following manner: a raw material containing cement as a main ingredient is shaped into a mat by wet sheet forming or semi-dry forming; the mat-shaped form is pressed using an embossing template to form an inorganic base board onto which a pattern such as a stone pattern, a ceramic tile pattern, a brick pattern, or a plastered wall pattern is transferred; then, the surface of this inorganic base board is coated with an opacifying pigmented paint such as a pigmented enamel paint so that the color of the base board is completely concealed; and, thus, the surface is colored to a desired color by performing color painting and, furthermore, pattern printing.

The above-mentioned color painting or pattern printing requires a series of coating facilities or printing facilities, and, in addition, much time and labor is required to change colors or patterns, which result in poor productivity. Furthermore, the above-mentioned opacifying pigmented paint of inorganic decorative building boards of this type contains a large amount of pigments such as a color pigment and a flatting pigment, so that during a long period of exposure to the weather or sunlight after construction, the paint layer of the above-mentioned opacifying pigmented paint undergoes age deterioration and, consequently, often exfoliates, discolors, and so on. For this reason, in some cases, the surface appearance of the inorganic decorative building boards is considerably impaired. Also, for example, the surface strength is reduced, and so the durability is also insufficient.

Moreover, the above-mentioned decorative boards coated with such an opacifying pigmented paint have a uniform, flat, featureless appearance due to the paint finish, so it has been difficult to form a decorative board having an appearance that provides the natural feel and look of natural materials possessed by stone, ceramic, bricks, and the like, by performing painting and printing as described above.

To address these issues, as disclosed in, for example, JP 5-194059A, JP 11-226491A, and JP 6-155424A, it has been known to decorate an inorganic base board with a pattern by fixing an ornamental powdery or granular material such as silica sand thereto to improve the decorativeness using the ornamental powdery or granular material or to simplify a painting step and improve the productivity.

Furthermore, JP 2001-207584A, which relates to a building board that is colored without using any painting technique and whose color development is not impaired, as well as a method for manufacturing the building board, provides a building board and a method for manufacturing the building board in which a resin or a waterproof additive is added to a colored surface layer in order to suppress the occurrence of efflorescence, which reduces the color development effect of a pigment and causes a defect in the colored base board, during the autoclave curing of a heat-treating step performed in the manufacturing process of the base board, thereby preventing color development of a pigment mixed in the material of the building board for coloring purpose from being impaired.

JP 2005-007334A provides an ornamental powdery or granular material dispersing device that is capable of non-uniformly dispersing a powdery or granular material with good controllability in order to provide the surface of a decorative building board with the natural non-uniformity and a method for manufacturing a decorative building board using this dispersing device. JP 2005-007834A also provides a method for manufacturing a decorative building board having excellent decorativeness, the decorative building board including a top surface portion that has a colored irregular pattern, and a powdery or granular material that is non-uniformly fixed to the top surface portion and that has a texture and a coloration different from those of the top surface portion.

JP 2005-088463A, which relates to an inorganic decorative board formed by performing semi-dry forming and then autoclave curing of a semi-dry composition containing cement and a wood material as main ingredients, provides a colored inorganic decorative board and a manufacturing method therefor. According to JP 2005-088463A, a color pigment and a bleached pulp serving as the wood material are mixed in a semi-dry composition that constitutes at least a surface portion, thereby preventing a stain-like unevenness of color from occurring in part of a colored surface layer after autoclave treatment. Thus, even in the case where a conventional color painting step is omitted, a considerable degradation in the surface appearance can be avoided, and the above-mentioned stain-like unevenness of color can be prevented from occurring on the colored surface layer while maintaining the advantageous effects of mixing a wood material with cement, i.e., weight reduction, reinforcement, and good formability of an inorganic mat.

An inorganic base board has complex, minute recesses like a burrow, and such recesses can decrease the adhesion of the base board to a finishing transparent paint layer and the waterproof properties or cause efflorescence after construction. However, conventionally, this problem has been concealed by applying an opacifying paint containing a large amount of pigments, such as a pigmented enamel paint, and has not become manifest. JP 2005-238075A proposes a method for manufacturing an inorganic decorative building board in which the surface of an inorganic base board is coated with a finishing transparent paint to allow the color of the surface of the base board to appear on the surface of the building board. In the proposed method, in order to satisfactorily fill the burrow-like, complex recesses that are present on the surface of a cement base board without loss of the transparency so that the adhesion of the base board to the transparent paint layer, the waterproof property, the efflorescence resistance, and the like can be improved, the surface of the cement base board after autoclave curing is coated with an undercoating transparent paint in which fine particles are mixed with a resin solution that, after hardening and becoming a hardened body, has transparency, the fine particles maintain the transparency of the resin of the hardened body, and the finishing transparent paint is applied onto the undercoating transparent paint.

In the case where an inorganic board is obtained by shaping a composition in which cement, a wood material, and a color pigment are mixed using a semi-dry forming method, and the inorganic board is hardened by autoclave curing, a stain-like unevenness of color can occur in part of the surface of a colored substrate layer after autoclave treatment. If a color painting step that has conventionally been performed on a surface layer is omitted, the unevenness of color on the colored substrate layer will remain on the surface, and so it has been extremely difficult to avoid such an unevenness of color on the colored substrate that considerably degrades the surface appearance. Furthermore, in the case where a base board whose substrate has been colored is cured in an autoclave, the color tone of the colored substrate layer changes depending on a combination of factors including the color tone of the cement, the color tone of the wood fiber, the color tone of silica sand, the external environmental conditions during manufacture, and the control conditions of the autoclave. However, it also has been difficult to completely control this change in color tone.

Meanwhile, with a method of dispersing an ornamental powdery or granular material onto the colored substrate layer before the formation of a design face, press forming for the formation of the design face causes the ornamental powdery or granular material to be embedded halfway into the top surface of the substrate. Furthermore, the press forming causes differences in the density of the dispersed ornamental powdery or granular material between flat and inclined portions of the design face. Therefore, in order to obtain sufficient decorativeness to satisfactorily express the natural non-uniformity and look of natural materials that are possessed by stone, ceramic tiles, and the like, improvements in the conformity of such an ornamental powdery or granular material to a pattern and further improvements in, for example, techniques for creating a subtle texture individually for each design piece have been desired.

### SUMMARY OF THE INVENTION

A first aspect in accordance with the present invention provides a decorative building board including a colored substrate layer and an ornamental powdery or granular material, the decorative building board having sufficient decorativeness to satisfactorily express the natural non-uniformity and look of natural materials that are possessed by stone, ceramic tiles, and the like, as well as reduced unevenness of color in the substrate and change in the color tone of the colored substrate layer that occur during autoclave curing and excellent weathering resistance, and a method for manufacturing the decorative building board with improved productivity, and to thereby manufacture a building board including a colored substrate that creates a natural atmosphere that painting techniques do not, as an industrial product with a steady quality.

In a second aspect in accordance with the present invention, a primary sealer is applied at a stage before autoclave curing, and a powdery or granular material fixing sealer is applied after autoclave curing to fix an ornamental powdery or granular material.

Specifically, an inorganic decorative building board according to a first embodiment of the invention includes a colored substrate layer; a coating film of a primary sealer that is formed on a surface of the colored substrate layer; a coating film of a powdery or granular material fixing sealer for fixing an ornamental powdery or granular material that is formed on the coating film of the primary sealer, wherein the ornamental powdery or granular material is fixed to a surface of the coating film of the powdery or granular material fixing sealer, and a coating of a transparent paint is applied so as to cover the ornamental powdery or granular material, the powdery or granular material fixing sealer, the primary sealer, and the colored substrate layer.

With the above-described configuration, the ornamental powdery or granular material is dispersed onto a colored base board, so the naturalness and look of natural materials are superior to those obtained in the case of using a conventional pigmented enamel paint. Furthermore, in contrast to a conventional colored decorative board obtained by dispersing an ornamental powdery or granular material before the formation of a design face such as an embossed pattern, the ornamental powdery or granular material is dispersed after the formation of a design face such as an embossed pattern. Thus, a decorative building board that has excellent decorativeness and looks real with the ornamental powdery or granular material providing the surface of the decorative building board with the natural non-uniformity and look of natural materials possessed by stone, ceramic tiles, bricks, or the like. Furthermore, the primary sealer suppresses the occurrence of efflorescence, and the ornamental powdery or granular material that covers the surface of the colored substrate layer suppresses unevenness of color in the colored substrate layer and change in the color tone of the colored substrate layer. According to the embodiment, since the ornamental powdery or granular material is dispersed after the formation of a design face such as an embossed pattern, a phenomenon in which, during press forming for the formation of the embossed pattern, the ornamental powdery or granular material is pressed into the substrate layer causing the substrate layer to be raised to the surface through the ornamental powdery or granular material does not occur.

According to an inorganic decorative building board of a second embodiment of the invention, the ornamental powdery or granular material is a mixture of a plurality of powdery or granular materials of different colors, particle diameters, and material properties.

With this configuration, in addition to the effect of the first embodiment of the invention, a decorative building board that enables the selection of the optimum mixing ratio and dispersing status for the ornamental powdery or granular material to provide the surface of the cement base board with a gradational pattern or a fine granular texture and further increase the naturalness and look of natural materials of the resultant design can be obtained.

According to an inorganic decorative building board of a third embodiment of the invention, the ornamental powdery or granular material is an inorganic powdery or granular material surface-treated with a glaze.

With this configuration, in addition to the effect of the first or second embodiment of the invention, a decorative building board that is less subject to color fading due to aging and exhibits a high weathering resistance performance can be obtained.

According to an inorganic decorative building board of a fourth embodiment of the invention, the primary sealer and the powdery or granular material fixing sealer are transparent.

With this configuration, in addition to the effects of the first to third embodiments of the invention, a decorative building board in which the base board color of the colored substrate layer appears on the surface of the decorative building board and forms a surface layer having excellent naturalness and look of natural materials can be obtained.

Fifth to seventh embodiments of the invention relate to a method for manufacturing an inorganic decorative building board, and the method according to the fifth embodiment of the invention includes the steps of shaping an unhardened inorganic board by press clamping a surface of an unhardened inorganic mat using an embossing template, the unhardened inorganic mat having a colored surface layer formed by forming a composition containing a self-hardening inorganic material and a wood material, as main ingredients, and a color pigment mixed in the main ingredients; performing primary curing of the unhardened inorganic board to obtain a semi-hardened inorganic board and coating a surface of the semi-hardened inorganic board with a primary sealer; autoclave curing the semi-hardened inorganic board coated with the primary sealer to obtain a hardened inorganic board; coating a surface of the hardened inorganic board with a powdery or granular material fixing sealer and thereafter dispersing an ornamental powdery or granular material onto the surface of the hardened inorganic board; and coating the surface of the hardened inorganic board on which the ornamental powdery or granular material has been dispersed with a finishing transparent paint.

According to this embodiment of the invention, the ornamental powdery or granular material is dispersed after the surface of the hardened inorganic board following autoclave curing is coated with the powdery or granular material fixing sealer, and the surface of the hardened inorganic board on which the ornamental powdery or granular material has been dispersed is coated with the finishing transparent paint. Thus, a decorative building board having the configuration and effect of the first embodiment of the invention can be manufactured with good productivity and controllability.

The sixth embodiment of the invention is the method for manufacturing an inorganic decorative building board according to the fifth embodiment, wherein the ornamental powdery or granular material is a mixture of a plurality of powdery or granular materials of different colors, particle diameters, and material properties.

Thus, a decorative building board having, in addition to the effect of the fifth embodiment of the invention, the configuration and effect of the second embodiment of the invention can be manufactured with good productivity.

The seventh embodiment of the invention is the method for manufacturing an inorganic decorative building board according to the fifth or sixth embodiment, wherein the ornamental powdery or granular material is an inorganic powdery or granular material surface-treated with a glaze.

Thus, a decorative building board having, in addition to the effects of the fifth and sixth embodiments, the configuration and effect of the third embodiment of the invention can be manufactured with good productivity.

An ordinary painted building board has a thin coating film thickness. Thus, in such a case where a scratch is made on the painted building board, the gray color of the inorganic base board itself is revealed, and the painted building board becomes very unsightly. It is inevitable that the appearance of such a painted building board is quite unendurable, unless the building board is repaired by painting over the scratch. In contrast, the colored building board according to the present invention has a colored surface layer having a certain level of thickness. Thus, the gray color, which is the original color of the inorganic base board, is not revealed by a little scratch, and an effect that makes the defect inconspicuous when seen from a distance can be obtained.

The surface of the inorganic base board after autoclave curing is coated with the powdery or granular material fixing sealer that, after hardening and becoming a hardened body, has transparency. The ornamental powdery or granular material is dispersed on the powdery or granular material fixing sealer, and the finishing paint having transparency is applied on the ornamental powdery or granular material. Thus, the base board color of the inorganic base board appears on the surface. Furthermore, the ornamental powdery or granular material is fixed to the surface of the inorganic base board having an embossed irregular pattern portion. Consequently, a decorative building board that has excellent decorativeness and looks real with the natural non-uniformity and look of natural materials possessed by stone, ceramic tiles, bricks, and the like appearing on the surface can be obtained.

In the step before the autoclave curing treatment, the primary sealer serving as an efflorescence-inhibiting paint is applied into the burrow-like recesses that are present on the surface of the inorganic base board without a loss of transparency. Thus, the coating film adhesion, the waterproof properties, and the efflorescence resistance after construction are improved. Therefore, an inorganic decorative building board having excellent durability and decorativeness can be manufactured.

### BRIEF DESCRIPTION OF THE DRAWINGS

FIG. 1 is partial plan view of an inorganic decorative building board according to an embodiment of the present invention.

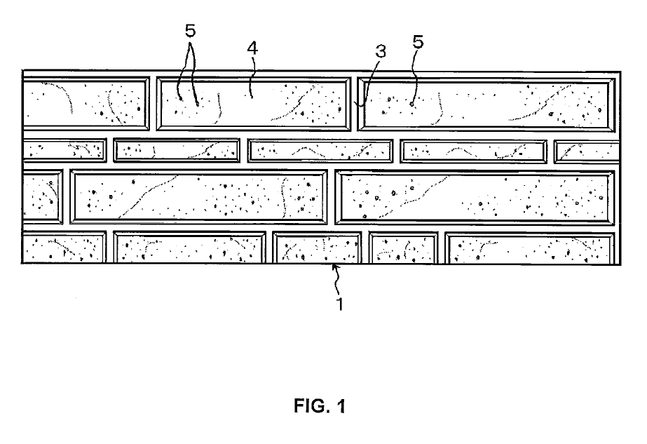

FIG. 2 is a partial cross-sectional view of the inorganic decorative building board of the present invention.

FIG. 3 is an enlarged cross-sectional view of a relevant part of the inorganic decorative building board of the present invention.

FIG. 4 is a flowchart illustrating a basic configuration of a method for manufacturing an inorganic decorative building board of the present invention.

### DESCRIPTION OF THE PREFERRED EMBODIMENT

Hereinafter, the best mode of the present invention will be described in detail based on the drawings. The following description of a preferred embodiment is provided essentially by way of example only and should not be construed as being intended to limit the present invention, items to which the present invention is applied, or applications of the present invention.

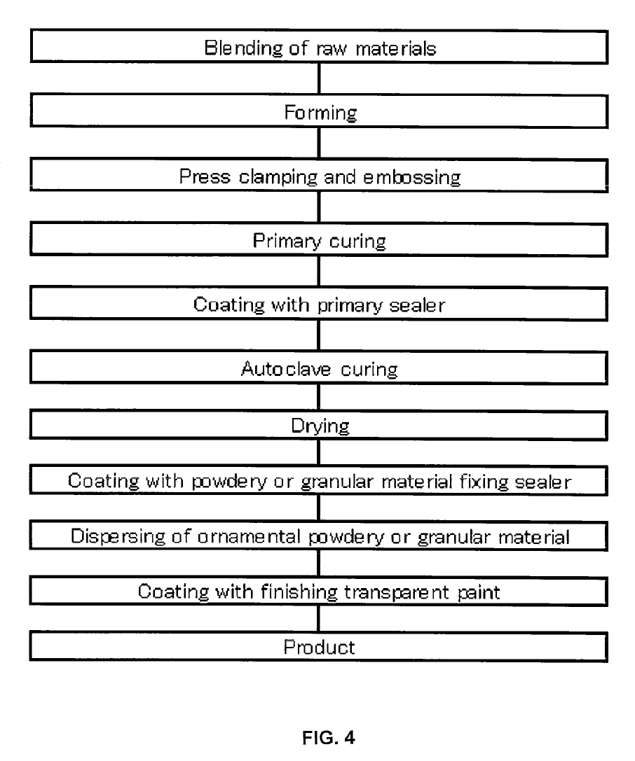

FIG. 4 shows the steps of a method for manufacturing an inorganic decorative building board A in which a three-layer wood-cement board that is shaped by a semi-dry forming method in an embodiment of the present invention is used as a base board.

### Blending of Raw Materials

An example of a semi-dry forming material for a surface layer contains a self-hardening inorganic material as a main ingredient, a wood material, inorganic foam such as perlite or shirasu balloons, and a color pigment and may further contain a hardening accelerator for cement, an efflorescence inhibitor, a water resistant additive, and the like.

Examples of the self-hardening inorganic material include cements, such as portland cement, slag cement, alumina cement, silica cement, fly ash cement, and portland blast-furnace slag cement; cement-silica-containing substance mixtures in which silica-containing substances, such as silica sand, shirasu, silicate pigment, silica rock powder, and silica fume, are mixed with the above-mentioned cements; gypsum; and magnesium carbonate. A hardening accelerator, such as magnesium chloride, magnesium sulfate, calcium chloride, calcium sulfate, sodium aluminate, potassium aluminate, aluminum sulfate, or water glass; and a mineral powder, such as bentonite or perlite, may be added to the above-described compositions.

Wood chips, wood flakes, wood pulp, wood fiber, wastepaper fiber, 6 bleached pulp, sawdust, wood flour, a ground product of waste wood-cement boards, or the like can be used as the wood material. It is desirable to use a relatively coarse wood material, such as wood chips or wood flakes, as the wood material used in a core layer 1b to reduce the weight thereof. Moreover, it is desirable to use a wood material that is finer than the wood material used in the core layer 1b, e.g., fine wood flakes, wood pulp, or wood fiber, as the wood material used in the surface layer and a back face layer to densify the surface and back face layers to improve the surface smoothness and strength properties.

In this embodiment, a color pigment is mixed in the surface layer or the surface and back face layers. Inorganic pigments, such as natural red iron oxide, artificial red iron oxide, synthetic iron oxide, titanium oxide, chromium oxide, and carbon black; ceramic pigments; and inorganic pigments in which organic pigments such as phthalocyanine blue arc mixed can be used as the color pigment.

In addition, inorganic foam, such as perlite and shirasu balloons, and chemicals, such as hardening accelerators, efflorescence inhibitors, and water resistant additives, can be mixed as raw materials for the surface and back face layers and the core layer 1b. Then, the water necessary for hardening cements and the like is added to these raw materials, and, thus, self-hardening semi-dry compositions are prepared.

A semi-dry forming material for the back face layer forms the back face layer 1c of the inorganic base board 1. The same material as the above-described semi-dry forming material for the surface layer or the semi-dry forming material for the surface layer excluding the color pigment is used as the semi-dry forming material for the back face layer, but the semi-dry forming material for the back face layer is not limited thereto.

Furthermore, a semi-dry forming material for the core layer forms the core layer 1b of the cement base board. The same material as the above-described semi-dry forming material for the surface layer or semi-dry forming material for the back face layer can be used as the semi-dry forming material for the core layer, but usually, tile semi-dry forming material for the core layer is prepared by mixing light-weight or inexpensive materials with cement. For example, materials that contain cement as a main ingredient, a siliceous material such as silica rock powder or silica sand powder, a wood material such as wood flakes, and inorganic foam such as perlite or shirasu balloon and may further contain a hardening accelerator for cement, an efflorescence inhibitor, a water resistant additive, and the like are preferable.

It should be noted that the method for shaping an unhardened inorganic mat is not limited to the above-mentioned semi-dry forming, and the unhardened inorganic mat can also be shaped by wet forming or by a combination of wet forming and semi-dry forming. Moreover, the layer structure of the unhardened inorganic mat is not limited to a three-layer structure as described above, and the unhardened inorganic mat can also have a single-layer structure or a two-layer structure.

### Forming

The steps before autoclave curing will be described. First, as shown in FIG. 4, forming of a wood-cement mat is performed. In this step, a support plate is placed and transported on a conveyor, and the semi-dry forming material for the back face layer, the semi-dry forming material for the core layer, and the semi-dry forming material for the surface layer are independently dropped from respective forming heads in that order and deposited on the surface of the moving support plate to form a three-layer wood-cement mat having a back face layer 1c, a core layer 1b, and a surface layer. It should be noted that the mat may be shaped using a wet sheet forming method, and the mat may have a single-layer structure or a two-layer structure. A template for forming a surface design of the decorative inorganic board may be placed on the surface of the above-mentioned support plate or may be placed on the surface layer after the formation of the wood-cement mat, and the position appropriate for the characteristics of the production process is selected. In the case where the template is placed on the surface of the support plate, the forming step is performed as follows: the semi-dry forming material for the surface layer, the semi-dry forming material for the core layer, and the semi-dry forming material for the back face layer are dropped from the respective forming heads in that order and deposited on the template placed on the moving support plate to form a three-layer wood-cement mat having a surface layer, a core layer 1b, and a back face layer 1c.

### Clamping and Embossing

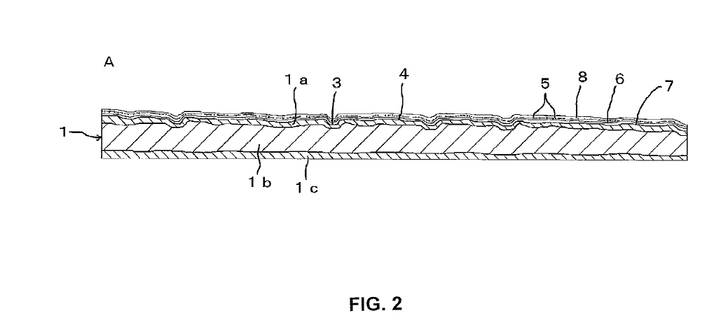

Next, an embossing template having recesses for forming a surface that is textured like, for example, a stone surface and projections for forming joint groove recesses is placed on the surface of the above-described wood-cement mat with the recesses and projections facing the surface of the mat, and then press clamping is performed. This operation forms, as shown in FIG. 2, an unhardened cement base board having a three-layer structure including the back face layer 1c made of the semi-dry forming material for the back face layer, the core layer 1b made of the semi-dry forming material for the core layer, and the colored surface layer 1a made of the semi-dry forming material for the surface layer, and having a surface portion textured like a stone surface 4 or the like and joint groove recesses 3. It should be noted that although the above-described template having a design face provided with recesses for forming a surface textured like a stone surface or the like and projections for forming joint groove recesses is preferable as the embossing template, the embossing template may also be a template having only surface-forming recesses or a template having a smooth face, and is not limited to a template having a face with both recesses and projections.

### Primary Curing

Then, the unhardened inorganic boards that are form-Led by the above-described press clamping and that have an embossed irregular pattern portion on the surface thereof are stacked one on top of the other, placed in, for example, a primary heating unit, and subjected to primary curing in the primary heating unit usually at a temperature of 50° C. to 80° C. for several hours to more than ten hours. The primary curing causes the unhardened inorganic board to be semi-hardened and provides the inorganic board with a suitable strength, so that the ease of handling is increased. After primary curing, the stacked inorganic boards are taken out from the primary heating unit and unstacked, and a semi-hardened inorganic board can thus be obtained. It should be noted that, after unstacking, the support plates and the embossing templates separated from the inorganic boards are reused.

Coating with Primary Sealer

Then, while the semi-hardened inorganic base board after the above-described primary curing is moved on a conveyor, the surface of the semi-hardened inorganic base board from which an embossing template have been removed is coated with a primary sealer by a spray coater. The coating device may be a device other than a spray coater, such as a sponge roller coater. The primary sealer generates a resin film on the surface of the base board. The generated resin film inhibits the passage of water through the surface of the substrate. Accordingly, the waterproof properties and the like of the surface of the semi-hardened inorganic base board are enhanced. In particular, during the subsequent autoclave curing step, the occurrence of efflorescence in the inorganic base board 1 is prevented, and so a good pigment color development effect can be achieved.

The above-described primary sealer is required to show transparency after being hardened, and, for example, a clear paint based on an acrylic resin emulsion, an acrylic styrene resin emulsion, an inorganic emulsion, a fluororesin emulsion, or the like, or a colored clear paint can be used. The coating amount of the primary sealer is desirably about 6 to 20 g/m² in terms of solids. By applying such a primary sealer coating, a primary sealer permeation layer having transparency is formed on the surface of the colored surface layer 1a of the inorganic base board 1 in the semi-hardened state. The primary sealer used here is a silicone acrylic emulsion sealer and has a non-volatile content of about 30%. The coating conditions are: a substrate preheating temperature of 50 to 60° C. and a drying temperature after primary sealer coating of 60 to 70° C.

As for resins that can be used as the above-described primary sealer, resins for mixing with cement are suitable, and examples thereof include polyvinyl acetate (PVAc), polymethyl methacrylate (PM), polyethyl methacrylate (PEMA), polystyrene (PSt), polyacrylonitrile (PAN), polymethacrylonitrile (PMAN), polyvinyl chloride (PVC), polyacrylic acid (PAA), polyvinyl alcohol (PVA), polyethylene (PE), polybutadiene (PBut), polyvinyl versatate (PVV), polyethyl acrylate (PEA), polybutyl acrylate (PBA), poly 2-ethylhexyl acrylate (P2EHA), polyvinylidene chloride (PVdC), polychloroprene (PCR), and their copolymers in the form of an emulsion. Examples of additives include stearate, calcium acrylate, ammonium oleate, asphalt emulsion, paraffin emulsion, hydroxyethyl cellulose, and maleic acid. As measures to prevent efflorescence, a method of adding an efflorescence inhibitor or an additive into the raw material or a method of applying a primary sealer to a template for shaping may be used in combination with the above-described primary sealer treatment.

### Autoclave Curing

Then, the semi-hardened inorganic base boards on which the films of the above-described primary sealer have been formed are stacked and autoclave cured. During autoclave curing, for example, ten inorganic base boards are stacke into a layer, and several layers of ten inorganic base boards are stacked one on top of the other with an iron spacer provided with many holes for passing vapor therethrough interposed between the layers. The autoclave curing is performed, for example, in a heated vapor atmosphere up to a maximum temperature of less than 180° C. for about 10 hours. The autoclave curing treatment may take a total of about 15 hours including the time required to raise the temperature of the inorganic base boards 1, lower the temperature thereof, and so on. Autoclave curing as described above sufficiently hardens the semi-hardened inorganic base board into a hardened inorganic base board.

### Drying

After the autoclave curing treatment, the above-described hardened inorganic base board is dried with a drier. Subsequently, the inorganic base board is cut into a predetermined size with a trimming saw, and, furthermore, a rabbet is formed by a rabbeting machine. Thereafter, the inorganic base board is loaded on a pallet by a loader and supplied to the subsequent coating step.

### Powdery or Granular Material Fixing Sealer Coating

Next, while the inorganic base board 1 after the above-described autoclave curing is moved on a conveyor, the surface of the inorganic base board is coated with a powdery or granular material fixing sealer 6 by a sponge roller coater to form a layer of the powdery or granular material fixing sealer 6. The surface of the colored surface layer 1a of the inorganic base board 1 is covered with this powdery or granular material fixing sealer 6. It should be noted that as long as a uniform coating of the powdery or granular material fixing sealer 6 can be applied to the surface of the base board on which an irregular pattern has been formed, the coating method of the powdery or granular material fixing sealer is not limited to a method using a sponge roller coater, and other coating methods using, for example, a roller coater and a spray coater can be used.

The above-described powdery or granular material fixing sealer 6 is made of a clear paint or a colored clear paint. Any resin solution can be used for this powdery or granular material fixing sealer 6 as long as the resin solution is a paint that shows transparency after hardening, toughens the surface of the colored surface layer 1a of the cement base board, increases the waterproof properties, is capable of firmly fixing an ornamental powdery or granular material 5, and has good weathering resistance, and there is no limitation on the type of resin of the resin solution.

### Dispersing of Ornamental Powdery or Granular Material

Next, an ornamental powdery or granular material 5 is dispersed from a dispersing head onto the surface of the thus obtained inorganic base board while the inorganic base board 1 is being moved on a conveyor. Natural color or colored powdery or granular materials can be used as such an ornamental powdery or granular material 5. For example, silica sand, artificially colored sand, mica, resin particles, and the ground products of stone, glass, brick, ceramic, and the like having a particle diameter of less than 3 mm can be used. To color the powdery or granular material, an inorganic pigment such as red iron oxide, titanium oxide, chromium oxide, or carbon black or a ceramic pigment can be used, or, furthermore, a surface treatment with a glaze can be employed. As for the above-mentioned colored ornamental powdery or granular materials, inorganic powdery or granular materials surface-treated with a glaze are less subject to color fading due to age deterioration and exhibit a high weathering resistance performance. It should be noted that a powdery or granular material having a particle diameter of 3 mm or more is too large and reduces the decorativeness and, therefore, is not preferable. Moreover, the ornamental powdery or granular material 6 may be a mixture of a plurality of ornamental powdery or granular materials of different colors, particle diameters, or material properties. The color of the ornamental powdery or granular material 5 may be different from or the same as the color of the colored surface layer 1a of the inorganic base board 1. The optimum mixing ratio and dispersing status for the ornamental powdery or granular material are selected to provide the surface of the cement base board with a gradational pattern or a fine granular texture to further increase the naturalness and look of natural materials of the resultant design.

Glazes such as ash glazes, iron-containing glazes, rock base glazes, matte glazes, emulsion glazes, crystalline glazes, celadon glazes, tenmoku glazes, copper glazes, low-fire glazes, and medium-fire glazes can be used as the glaze applied to the ornamental powdery or granular material 5.

Coating with Finishing Transparent Paint

Thereafter, while the inorganic base board 1 is moved on a conveyor, a coating of a finishing transparent paint is applied onto the top surface of the ornamental powdery or granular material 5 that has been dispersed on the above-described powdery or granular material fixing sealer 6 to form a finishing transparent paint layer. Acrylic silicone resin paints, fluororesin paints, acrylic resin emulsion paints, and inorganic paints can be used as the finishing transparent paint, and the finishing transparent paint can be applied using a spray coater. The finishing transparent paint may also be applied using other coaters, for example, a roller coater such as a sponge roller. It should be noted that a plurality of coats of such a finishing transparent paint 7 further improves the weathering resistance. The total coating amount of the finishing transparent paint 7 is about 10 to 100 g/m² in terms of solids. Also in the case of this finishing transparent paint 7, clear paints and colored clear paints can be used.

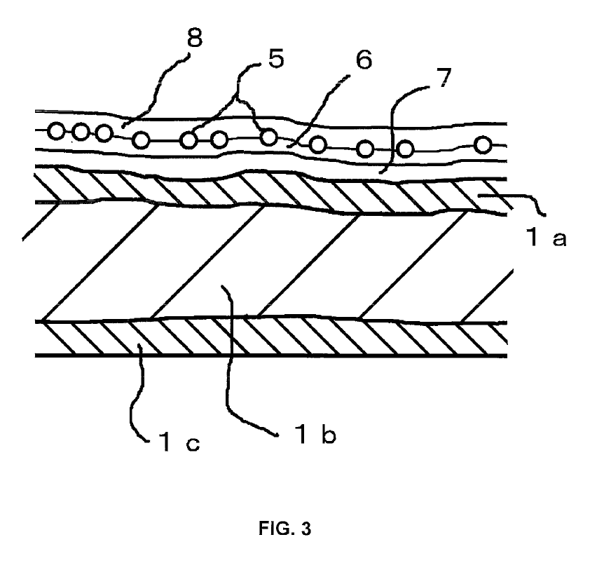

An inorganic decorative building board A as shown in FIGS. 2 and 3 can be obtained in the above-described manner. The thus obtained inorganic decorative building board A presents a highly decorative appearance with the color tone of the colored surface layer 1a that appears through the primary sealer layer, the powdery or granular material fixing sealer layer, the fixed powdery or granular material layer, and the finishing transparent paint layer and the color tone of the ornamental powdery or granular material 5 being in harmony with each other.

The inventor of the present invention performed an accelerated weathering test using a sunshine type UV testing machine and a freeze-thaw test on an inorganic decorative building board A having the structure of the above-described embodiment. It was found from these tests that there is no problem with the film adhesion, the waterproof properties, and the efflorescence resistance of the inorganic decorative building board A, and the inorganic decorative building board A also showed excellent durability without any coating film exfoliation or discoloration.

According to the present invention, a plurality of powders or granules of the ornamental powdery or granular material 6 mixes with the color tone of the colored surface layer 1a of the substrate in a natural manner to create a subtle color tone, and the ornamental powdery or granular material 5 conforms to the irregularities of the design surface to produce a subtle feel to the irregularities of the design surface. Thus, an inorganic decorative building board A that has excellent decorativeness and expresses a natural texture that has been difficult to express using conventional painting techniques can be manufactured. Therefore, the present invention is extremely useful and has good industrial applicability.

What is claimed is:

1. An inorganic decorative building board comprising:
a colored substrate layer;
a coating film of a primary sealer that is formed on a surface of the colored substrate layer; and
a coating film of a powdery or granular material fixing sealer for fixing an ornamental powdery or granular material that is formed on the coating film of the primary sealer,
wherein the ornamental powdery or granular material is fixed to a surface of the coating film of the powdery or granular material fixing sealer; and
a coating of a transparent paint is applied so as to cover the ornamental powdery or granular material, the powdery or granular material fixing sealer, the primary sealer, and the colored substrate layer.

2. The inorganic decorative building board according to claim 1, wherein the ornamental powdery or granular material is a mixture of a plurality of powdery or granular materials of different colors, particle diameters, and material properties.

3. The inorganic decorative building board according to claim 1, wherein the ornamental powdery or granular material is an inorganic powdery or granular material surface-treated with a glaze.

4. The inorganic decorative building board according to claim 2, wherein the ornamental powdery or granular material is an inorganic powdery or granular material surface-treated with a glaze.

5. The inorganic decorative building board according to claims 1, wherein the primary sealer and the powdery or granular material fixing sealer are transparent.

6. The inorganic decorative building board according to claims 2, wherein the primary sealer and the powdery or granular material fixing sealer are transparent.

7. The inorganic decorative building board according to claims 3, wherein the primary sealer and the powdery or granular material fixing sealer are transparent.

8. The inorganic decorative building board according to claims 4, wherein the primary sealer and the powdery or granular material fixing sealer are transparent.

9. A method for manufacturing an inorganic decorative building board, comprising the steps of:
shaping an unhardened inorganic board by press clamping a surface of an unhardened inorganic mat using an embossing template, the unhardened inorganic mat having a colored surface layer formed by forming a composition containing a self-hardening inorganic material and a wood material, as main ingredients, and a color pigment mixed in the main ingredients;
performing primary curing of the unhardened inorganic board to obtain a semi-hardened inorganic board and coating a surface of the semi-hardened inorganic board with a primary sealer;
autoclave curing the semi-hardened inorganic board coated with the primary sealer to obtain a hardened inorganic board;
coating a surface of the hardened inorganic board with a powdery or granular material fixing sealer and thereafter dispersing an ornamental powdery or granular material onto the surface of the hardened inorganic board; and
coating the surface of the hardened inorganic board on which the ornamental powdery or granular material has been dispersed with a finishing transparent paint.

10. The method for manufacturing an inorganic decorative building board according to claim 9, wherein the ornamental powdery or granular material is a mixture of a plurality of powdery or granular materials of different colors, particle diameters, and material properties.

11. The method for manufacturing an inorganic decorative building board according to claim 9, wherein the ornamental powdery or granular material is an inorganic powdery or granular material surface-treated with a glaze.

12. The method for manufacturing an inorganic decorative building board according to claim 10, wherein the ornamental powdery or granular material is an inorganic powdery or granular material surface-treated with a glaze.
